(19) United States
(12) Patent Application Publication
(10) Pub. No.: US 2018/0347869 A1
(43) Pub. Date: Dec. 6, 2018

(54) TEMPERATURE CONTROL DEVICE

(71) Applicant: Saint Claude, Blagnac (FR)

(72) Inventors: Anthony Boule, Toulouse (FR); Pierre Lapalus, Marseille (FR)

(21) Appl. No.: 15/552,680

(22) PCT Filed: Feb. 22, 2016
(86) PCT No.: PCT/EP2016/053683

§ 371 Date: Aug. 22, 2017

(30) Foreign Application Priority Data
Feb. 23, 2015 (FR) 15 51519

(51) Int. Cl. F25B 21/04

(52) U.S. Cl. CPC F25B 21/04; G05D 23/1919

(57) ABSTRACT

The invention relates to a portable device (100; 200; 400) for regulating the temperature of an element (1), comprising: an engagement part (2) adapted to be placed in contact with the element (1), a temperature regulation unit (3) comprising a thermoelectric module (4) having two sides (41, 42), a first side (41) of the thermoelectric module being thermally coupled with the engagement part (2). The device (100; 200; 400) further comprises: a reception part (5) adapted to removably receive a phase change material (PCM) (6), a second side (42) of the thermoelectric module being thermally coupled with the reception part (5), such that a phase change material (PCM) (6) provided in the reception part will also be thermally coupled with the second side (42) of the thermoelectric module.

### TECHNICAL FIELD

The invention relates to temperature regulation. More particularly, the invention relates to a device and a method for regulating the temperature of an element.

### STATE OF THE PRIOR ART

Numerous means for regulating temperature exist including, for example, vapour compression cycles, boilers, chemical reactions and thermoelectric effect means.

In particular, the thermoelectric effect (or Peltier effect) is the direct conversion of a difference in temperature between two sides of a conductor into an electrical voltage, and vice versa. The use of this technology to regulate temperature has taken off during the last few years, due to the fact that a thermoelectric module contains no moving parts, requires little maintenance and offers a long working life. Moreover it does not comprise heat transfer fluids such as refrigerants. Furthermore a thermoelectric module may be very small in size, which is ideal for use in an area of limited space and for portability. A thermoelectric module also allows precise control of temperature by simply adjusting its supply voltage.

An example of the use of a thermoelectric module for regulating temperature is described in published patent application FR 2 961 080 A1 (by the applicant). This document describes a device comprising a wine decanter and several Peltier effect (thermoelectric effect) modules arranged on the decanter. The temperature of a liquid contained in the decanter may be regulated by means of a processor which controls the voltage at the terminals of the Peltier effect modules in order to heat or cool the liquid.

Other examples of thermoelectric modules used in particular for cooling are described in patent application US 2002/0162339 A1.

The above examples suffer however from a lack of efficiency since their thermoelectric modules, which operate by absorbing or discharging thermal energy into the environment, depend on the absorption from or the loss of energy to their environment and are therefore reliant on the ambient temperature which often does not provide a sufficient differential temperature, and which is furthermore subject to fluctuations.

### BRIEF DESCRIPTION OF THE INVENTION

The aim of the present invention is consequently to remedy the aforementioned needs and drawbacks by offering an effective and simple-to-use temperature regulation device and method.

The present invention thus proposes a portable device for regulating the temperature of an element, said device comprising:

i) an engagement part adapted to be placed in contact with the element,

ii) a temperature regulation unit comprising a thermoelectric module having two sides,

a first side of said thermoelectric module being thermally coupled with the engagement part, characterised in that the device further comprises:

iii) a reception part adapted to removably receive a phase change material (PCM), a second side of said thermoelectric module being thermally coupled with the reception part, such that a phase change material (PCM) provided in said reception part will also be thermally coupled with said second side of said thermoelectric module.

By the term “regulating the temperature of an element” it is meant that the device is capable of maintaining the temperature of the element substantially constant and equal to a setting temperature (within a close margin of tolerance). Typically this setting temperature is selected, directly or indirectly, by the user.

The device may further comprise one or more of the following characteristics, taken separately or according to any technically admissible combination.

The engagement part preferably comprises a heat-transfer plate.

More preferably, the engagement part comprises a carafe for decanting and aerating a liquid. The carafe may be a single-piece carafe or a carafe comprising a removable bell and a base, said base being a heat-transfer plate.

Preferably, the engagement part, the temperature regulation unit and the reception part are integral with the device.

More preferably, the entire device is adapted to be tilted in order to pour a liquid from the device.

Preferably, the reception part comprises a phase change material (PCM) of a predetermined mass. More preferably, said phase change material (PCM) is provided in a removable container.

Preferably, the phase change material (PCM) is a material chosen from amongst the following materials: water, paraffin, salt hydrates, dry ice (carbon dioxide), disodium orthophosphate dodecahydrate, wax or any combination of two or more materials. Advantageously, during use, the thermal energy supplied to or extracted from the element by the thermoelectric module is substantially respectively extracted from or supplied to the phase change material (PCM).

Preferably, the temperature regulation unit comprises a Peltier effect type thermoelectric module.

More preferably, the module is controlled by a processor as a function of a selected temperature. Advantageously, the module is further controlled by the processor as a function of a recommended time period.

Preferably, the temperature for a wine is selected depending on a type of wine selected, with the computer being fed a temperature from a database connected to the computer, based on the type of wine selected, and also a recommended aeration period for said type of wine.

The present invention also proposes a method for regulating the temperature of an element which uses a portable device to regulate the temperature of an element as described previously, wherein the method comprises the following steps:

i) thermally coupling a first side of a thermoelectric module exhibiting a first thermal effect with the element,

ii) removably providing a phase change material (PCM) of predetermined mass,

iii) thermally coupling a second side of said thermoelectric module exhibiting a

second effect with the phase change material (PCM),

such that the energy supplied to or extracted from the element is extracted from or supplied to the latent heat of the phase change material (PCM), such that the phase change material (PCM) undergoes, at least in part, a change of phase.

### BRIEF DESCRIPTION OF THE FIGURES

Descriptions of embodiments of the invention will be described in what follows as non-restrictive examples, with reference to the appended illustrations, in which:

FIG. 1 schematically shows a portable device for regulating the temperature of an element;

FIG. 2 shows a vertical sectional view of a device according to a first embodiment of the invention;

FIG. 3 shows a horizontal sectional view of a device according to the first embodiment;

FIG. 4 shows a sectional view of a second embodiment of the invention.

In all of these figures, identical references may designate identical or similar elements. Furthermore, in order to make the figures more readable, the various parts shown in the figures are not necessarily shown at a uniform scale.

### DETAILED DESCRIPTION OF PARTICULAR EMBODIMENTS

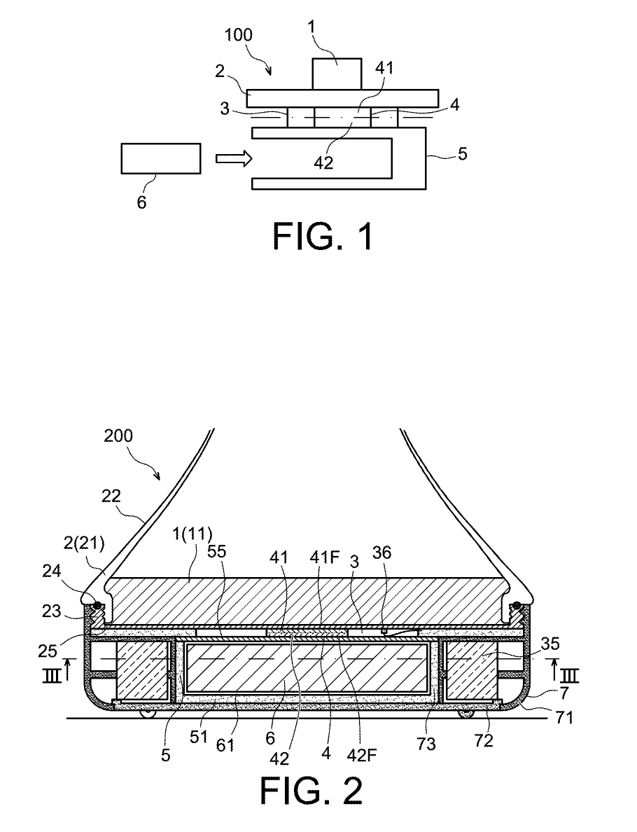

FIG. 1 schematically shows a portable device 100 for regulating the temperature of an element 1. It comprises an engagement part 2 adapted to be placed in contact with the element 1. The engagement part 2 is thus named since it is adapted to be engaged with the element 1. For example, this may be a carafe or a plate or, more generally a container in the broader sense, and will depend on the nature of the element. The element 1 may in turn be a food product, a solid, a liquid, a product or any element whatsoever in the form of matter.

The device 100 also possesses a temperature regulation unit 3 comprising a thermoelectric module 4, the thermoelectric module 4 having two sides 41, 42. A first side 41 is in thermal contact with the engagement part 2 and a second side 42 is in thermal contact with a reception part 5. The temperature regulation unit 3 preferably comprises, in addition, the components which allow the thermoelectric model 4 to operate and to be controlled, such as a processor, a memory, a sensor and accumulator batteries.

The reception part 5 is adapted to removably receive a mass of phase change material (PCM) 6. As the reception part 5 is in thermal contact with the thermoelectric module 4, a PCM 6 placed in this part 5 will also be thermally coupled with the thermoelectric module 4. Further details, as well as other preferable characteristics, are described hereinbelow with reference to the preferred embodiments.

The device of the invention for temperature regulation will now be described with reference to one of the preferred embodiments.

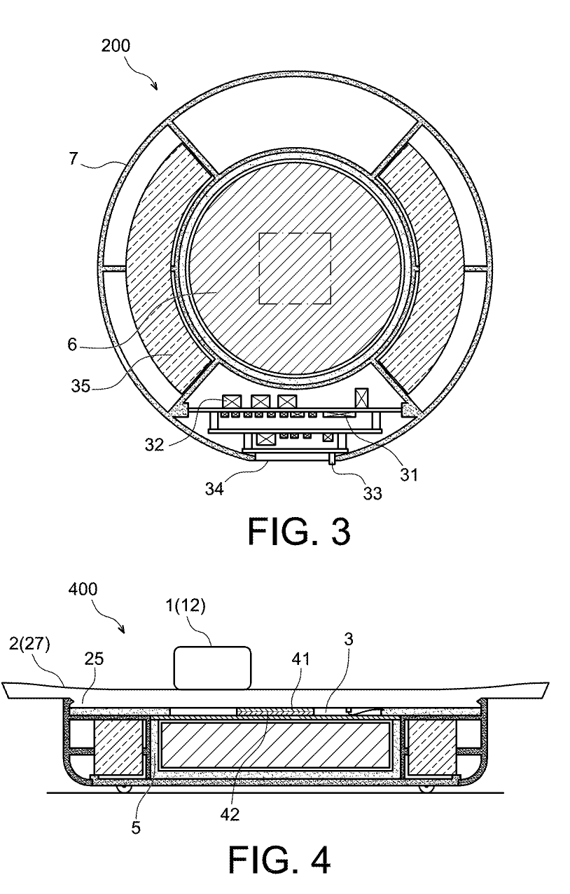

FIGS. 2 and 3 show a temperature-regulating wine carafe device 200 intended to heat and cool a volume of wine 11 according to a first embodiment. The device 200 is portable, has a self-contained energy supply and is intended for table-service.

The device 200 comprises a temperature regulation unit 3 which comprises a thermoelectric module 4, and a reception part 5 adapted to receive a PCM 6. It also has an engagement part 2 adapted to engage an element 1 which requires temperature regulation.

The engagement part 2 corresponds to a carafe 21 which is a container specially adapted for decanting and aerating a volume of liquid, for example wine.

The carafe 21 is made of two parts. The first part is a bottomless bell 22, made of glass or crystal, and the second part is a base 23 which is a heat-transfer plate 25 made from a material which has high thermal conductivity, for example of food-grade aluminium or stainless steel. The bell 22 and the base 23 have complementary threaded means which allow them to be fixed together. An O-ring 24 is placed at their interface to provide a sealed connection between the two. The carafe 21 is designed to be removable, thus allowing it to be easily cleaned.

The temperature regulation unit 3, comprising the thermoelectric module 4, is arranged below the engagement part 2. It furthermore comprises a processor 31 for controlling the thermoelectric module 4, a memory 32 wherein the parameters or the information required for the operation of the device 200 are stored, a means of input 33 for selecting the temperature and a display 34.

The device 200 also comprises a voltage source 35, for example batteries, to supply the temperature regulation unit 3. A housing 7 contains most of these components of the temperature-regulating wine carafe 200. The housing 7 is designed with threaded means which complement those located on the base 23, so that they can be assembled together. The reception part 5, adapted to receive a PCM 6, is arranged below the thermoelectric module 4. A mass of PCM 6 is also present. This will be discussed in further detail below.

The thermoelectric module 4 works along the principles of the Peltier effect. It has two main sides, an upper side 41 (first side) with an upper face 41F and a lower side 42 (second side) with a lower face 42F. When the module 4 is supplied with an electrical voltage it generates a temperature difference, as well as a flow of heat, between the upper side 41 and the lower side 42. The module 4 therefore exhibits a first thermal effect on the upper side (in particular on the upper face 41F), and a second thermal effect on the lower side 42 (in particular on the lower face 42F). Furthermore, if the voltage at the terminals of the thermoelectric module 4 is inverted the thermal effects exhibited at the two sides (or faces) will be reversed.

During use, the temperature difference and heat flow are substantially dependent on the supply voltage of the thermoelectric module 4, on the temperature of the PCM 6 and on the temperature of the element 1 (the wine 11). Since there is good thermal coupling between the element 1 and the upper face 41F of the thermoelectric module 4 and between the lower face 42F of the thermoelectric module 4 and the PCM 6, the temperatures of the faces 41F, 42F of the thermoelectric module 4 are more or less fixed at any given instant, and an adjustment the electrical supply voltage to the thermoelectric module 4 will essentially cause the heat flow extracted from or supplied to the element 1 to vary.

The upper side 41 of the thermoelectric module is arranged in such a way that it is in thermal contact with the carafe. In particular, it is located in such a way that its upper face 41F is in thermal contact with the base 23 of the carafe 21.

The thermoelectric module 4 operates under the control of the processor 31. The processor 31 thus controls the voltage to the terminals of the thermoelectric module 4 as a function of the selected temperature and of the temperature measured by a temperature sensor 36, intended to measure the temperature of the liquid 1. The temperature sensor 36, or possibly another sensor, may furthermore be used to detect the presence of liquid in the carafe 21. Thus the processor 31 controls the thermoelectric module so that the wine 11 reaches the selected temperature.

The temperature is chosen by using the buttons 33 on a keypad. The display 34 shows the selected temperature as well as the current temperature of the wine 11. Other configurations of the means of input for selecting the temperature can be envisaged. For example a rotary switch may be envisaged for selecting the temperature. Alternatively a touch screen which allows the temperature to be selected with greater precision may be used, and on which other information such as the aeration time may also be selected.

Depending on the temperature chosen, the processor 31 is adapted to invert the polarity of the voltage to the terminals of the thermoelectric module such that the thermal effects present at the first and second sides 41, 42 are reversed. In other words, the same side of the module will heat the wine instead of cooling it. Naturally several modules may be envisaged. It is also possible to provide a first set of modules dedicated to heating and a second set dedicated to cooling.

A recess 51 is provided in the base 71 of the device to receive a mass of PCM 6. Access to the recess may be closed off by a cover 72. The cover 72 is connected to the base 71 of the housing 7 of the device by a bayonet-type connection, although any other connection which enables quick and easy detachment and removal or replacement of the PCM 6 may be used.

The device 200 comprises a predetermined mass of PCM 6. A PCM is a phase change material which uses its latent heat of fusion or evaporation to absorb or to supply heat. The PCM 6 is arranged in the reception part 5 which is in thermal contact with the lower side 42 of the thermoelectric module 4. The PCM 6 is therefore also in thermal contact with the module 4. Note that a heat conduction plate 55 may be placed between them so as to distribute the transfer of thermal energy between the PCM 6 and the thermoelectric module 4 in a more uniform manner.

The choice of PCM 6 will depend on the specific application and on the element 1 whose temperature has to be adjusted. By way of example, the PCM 6 may be chosen from amongst the following materials: paraffin, disodium orthophosphate dodecahydrate, salt hydrates, water, dry ice (CO₂) or wax. A combination of these materials may also be suitable. The quantity, or mass, of PCM 6 is ideally provided in a sealed container 61 so as to prevent it spilling when it is in a liquid phase, and in order to prevent any direct contact during handling. The container 61 is made of a material which has a high thermal conductivity and which does not prevent the transfer of thermal energy towards and from the PCM 6, and effectively forms a compact “block of PCM”.

The temperature-regulating wine carafe 200 will first of all be discussed in relation to cooling a volume of wine 11.

A volume of white wine 11 at 15° C. is poured into the device. The user wants to consume it at a recommended temperature of 8° C., and thus selects this temperature by pressing, for example, on a button 33 until the desired temperature is displayed. The temperature sensor 36 on the base 71 of the device 200 detects the temperature of the liquid in the carafe 21, for example by detection of the temperature of the base 23 of the carafe 21. The sensor 36 is connected to the processor 31 of the device and indicates that the liquid 11 is not at 8° C., and must therefore be cooled.

The device 200 therefore starts to cool the volume of wine 11. In particular, the thermoelectric module 4 exhibits a cooling effect on the upper side 41 which is in contact with the base 23 of the carafe, whereas the lower face 42 consequently exhibits a heating effect. The thermoelectric module 4 of the temperature regulation unit 3 therefore pumps the thermal energy of the wine 11 towards the PCM 6.

The block of PCM 6 is located inside the reception part 5, which is the recess 51 in the base 7 of the device 200. The PCM 6, which in this case is water ice, has been previously cooled in a standard domestic freezer and is frozen, with a temperature below its melting point of 0° C., for example equal to −5° C. The PCM 6 then starts to absorb the thermal energy from the hot side 42 of the thermoelectric module. This energy comes from the wine 11, so the wine 11 therefore starts to cool. The temperature sensor 36 monitors the temperature of the wine. The device 200 regulates the temperature of the wine 11 based on the temperature measured by the sensor 36 and from the selected temperature. Depending on the difference between the measured temperature of the element and the selected temperature, the processor 31 determines the command to apply to the thermoelectric module 4.

As the PCM 6 gradually absorbs the heat, its temperature increases until it reaches the melting point of the PCM of 0° C. The heat flow transferred from the wine 11 to the PCM 6 through the thermoelectric module 4 then causes the ice to melt gradually and the mixture of water and ice remains at its melting temperature of 0° C. (until its entire mass becomes liquid).

When the wine reaches the selected temperature of 8° C., this will be detected by the temperature sensor 36 and the processor 31 reduces the cooling significantly in order not to cool the wine 11 too much. The device 200 then emits an audible and/or visual signal to indicate that the wine is at the chosen temperature and ready for consumption. The user may then lift and tilt the entire device 200 in order to pour a portion of wine 11 into a glass.

Since the wine is likely to be consumed all at once, the device 200 is programmed to maintain the wine 11 at the chosen temperature for a predetermined period, for example 1 hour, or until all the wine 11 is consumed. Consequently the temperature of the wine 11 will be maintained at the ideal temperature for consumption for the approximate duration of a meal.

Depending on the type and composition of the PCM 6, it may be capable of absorbing a large quantity of heat, corresponding at least to its latent heat of fusion. So the PCM 6, which effectively acts as a heat dissipater for the thermoelectric module, remains at a constant temperature, equal to 0° C. because the PCM 6 is in this example ice, until all the ice has melted. Beyond this the temperature of the PCM 6 will begin to rise once more. Therefore, if the device 200 has been left to cool the wine 11 for a long period, the ice 6 will finally be all melted.

Advantageously, the device comprises sensors to measure the temperature of the PCM 6, or to identify that the latter is already “used”, in order to establish whether the PCM 6 must be replaced.

Once all the wine 11 has been consumed, or when the PCM 6 has completely melted, the block of PCM 6 may be withdrawn and simply placed in a freezer to solidify once more.

Advantageously the carafe 21, the temperature regulation unit 3 and the PCM 6 reception part 5 are combined in a single unit, although it is composed of several parts. The device 200 is designed such that the mass of PCM 6 placed in the reception section of the device 200 substantially forms a single unit with the remainder of the device. A design of the device as a single unit is preferable, in particular in the embodiment of a temperature-regulating wine carafe which needs to be tilted. Naturally other embodiments may also exist such as, for example, an embodiment where the device comprises a single-piece carafe made of glass adapted to be separated from the rest of the device in order to allow decanting, or when the device is made of a single unit, but designed to be lifted off the block of PCM when pouring the wine, and replaced on the block for temperature regulation to continue.

The temperature-regulating wine carafe 200 will now be discussed in relation to the heating of a volume of wine 11.

This time the PCM 6 has a melting point greater than the desired temperature of the wine 11. A wax, for example, which solidifies at 40° C., is thus chosen as the PCM 6. As before the PCM 6 is supplied in a container 61. The block of wax is immersed in a hot water bath so that the wax completely melts inside it and such that its temperature is greater than 40° C., for example at 50° C. This block is then located in the reception part 5 of the device 200 and made secure. It is located in a space with insulation 73 such that only the upper face is exposed and in thermal contact with the thermoelectric module 4.

A red wine 11 at 10° C., which the user wishes to heat to a recommended temperature of 18° C., is poured into the carafe. The device 200 detects the presence of a liquid 11 and the temperature of the liquid 11, and is now ready to be operated. The user selects the temperature of 18° C. Moreover, considering that it is a red wine, the user enters a recommended aeration time of one hour into the device.

The thermal energy of the PCM 6 is pumped towards the wine 11 by the thermoelectric module 4. The temperature of the wax 6 in the block will fall, until it reaches 40° C., a temperature which will be maintained. It continues to supply energy to the thermoelectric module 4 such that the temperature of the wine 11 increases and reaches the selected temperature of 18° C. A part of the energy supplied by the batteries 35 in order to operate the thermoelectric module may also contribute towards heating the wine 11. There may also be a transfer of energy between the PCM 6 and the wine which passes around the thermoelectric module 4.

Heating is achieved within an hour in order to bring the temperature of the wine 11 to the recommended level. This gradual heating prevents “shocking” the wine 11 as a result of the heating. This is of particular importance for high quality red wines. As before, the device 200 emits an audible signal and/or a visual signal once the desired temperature has been reached. The user can now consume the wine 11 at the recommended temperature for consumption, with also being sufficiently aerated. The user lifts the entire device 200 and tilts it in order to pour the wine 11 into a glass.

When all the wine 11 has been consumed, or when the device shows that the PCM 6 has been “used”, that is, it has frozen into a solid state, the PCM 6 block is removed and placed in a warm water bath or on a radiator to be re-melted. In the meantime another “unused” block may be placed in the reception part 5 if necessary. With the right choice of PCM 6 and its mass are correctly chosen, the device 200 will be capable of regulating temperature without the PCM 6 needing to be replaced half-way through the process or in service. The PCM 6 may possibly even be capable of providing temperature regulation several times, allowing, for example, several successive services in the restaurant application without replacing the PCM 6.

It should be noted that the important aspect for operation of the device is the ability of the PCM 6 to be maintain a constant temperature (the melting or evaporation point) for a prolonged period. The PCM may therefore have a melting point between −20 ° C. and 40° C., for example of 0° C., 6° C., 15° C., 23° C. or 40° C., chosen depending on the nature of the element and whether the element must be heated or cooled. Furthermore, it is not essential for the melting point of the PCM to be greater than the desired temperature of an element to be heated. A PCM with a melting point which is between the starting temperature, that is before regulation, and the desired temperature of an element may also be suitable. In the example where the red wine is heated, a PCM with a melting point of 15° C. may also be appropriate.

Although the above embodiment is described as a temperature-regulating wine carafe, it should be noted that this embodiment will also be applicable to other liquids. For example the engagement part may be a glass or a coffee pot, and the device may regulate the temperature of tea or coffee.

FIG. 4 shows a second embodiment of the invention. This temperature-regulating plate device 400 for foodstuff may be used to keep food (for example ice, sushi or caviar) cool during a meal.

Although the temperature regulation unit 3 and the reception part 5 are substantially the same, the engagement part 2, instead of being a carafe 21, is a plate 27 for receiving foodstuff 12. The plate 27 is a heat-transfer plate 25, for example made of food-grade aluminium or stainless steel, and substantially takes the form of a food dish in this embodiment.

The plate 27 is in thermal contact with the first side 41 of the thermoelectric module. The plate can hold several pieces of foodstuff (sushi, a portion of caviar or perhaps some cold meat), and maintain them at an ideal temperature for consumption. Of course, a carafe or a bottle may be placed on the temperature regulation plate to be heated or cooled. As before, the PCM 6 is in thermal contact with the second side 42 of the thermoelectric module 4 in order to absorb the thermal energy.

Although described in relation to food, the device 400 may find applications in other fields. The device 400 may be used with a product. For example it may be used to liquefy wax for women to wax their legs.

It should be noted that in the embodiments described above there is very little transfer of energy between the device 200 and the ambient environment. That is, in regulating the temperature of an element 11, the heat absorbed from the element to be cooled is primarily stored in the device 200, whereas the heat lost to the element 11 being heated also comes substantially from the inside of the device 200. When a volume of wine 11 is cooled by the device 200 on a buffet stand, the heat resulting from the cooling of the wine 11 will not be discharged to the exterior where it could adversely affect other food products. In this sense the device 200 is independent and does not depend on or “disturb” the environment, unlike many other temperature regulation devices. Neither does it need to use a fan to create a flow of air for effective removal of energy from the side 42 of the thermoelectric module 4, and is therefore very quiet. This makes it very suitable for tables, buffet stands, hospital rooms and noise-sensitive locations. It should also be noted that the device 200 does not need to be connected to the mains electricity supply during operation, and is therefore safer and suitable for all types of environment where the liquid may be splashed onto the device.

Other advantageous aspects may also be incorporated. For example the display screen 34, in addition to indicating the temperature of the wine and the selected temperature, may additionally be configured to usefully show other information such as the operating life of the battery, the status of the PCM, the remaining temperature regulation time or aeration time.

In another embodiment, instead of selecting a desired temperature, a user may select a type of wine, for example of the Bordeaux (red) type. When this instruction is received, the processor 31 will control the thermoelectric module and a designated temperature for this type of wine may be chosen, for example 18° C., from the memory 32 of the device. Alternatively, instead of selecting a general category or type of wine, the temperature regulation instructions for the exact type of wine, year and region, amongst other characteristics, may be selected. For example, the details of the wine may be scanned on a bottle of wine from a Smartphone mobile phone. The Smartphone connects to an on-line database, maintained by the wine producer's cellar master. This database will contain information on the recommended temperature for consumption of this particular wine, and in addition the duration of the ideal aeration period. All the relevant information will be downloaded into the Smartphone and transmitted to the temperature regulation device 200. The device 200 will then heat or cool the wine automatically. Once this is done, the device 200 sends a notification to the Smartphone to inform the proprietor that the wine is ready to be consumed (as recommended by the experts).

The present invention is distinct from the prior art in that it can receive a PCM 6 in a removable or replaceable manner, a characteristic which is closely connected to the manner in which the device is to be used. This allows a quantity of heat to be provided or removed much more quickly.

In other alternatives of the invention, instead of providing a block containing the PCM, the PCM can be provided directly in the reception part if it is designed in an appropriate manner. In another embodiment, the device may be provided with a block of dry ice of frozen carbon dioxide. When the dry ice absorbs energy during a cooling temperature regulation process it undergoes sublimation and is released from the device. This has the secondary effect of providing a pleasant aesthetic effect. Although the PCM was removable at the beginning, in this case the PCM will naturally no longer be removable or recoverable after use. More PCM may nevertheless be added.

In general the device is typically envisaged with a container as the engagement part. This container will preferably be removable.

It should be noted that the expressions “thermal contact” and “thermally coupled” do not necessarily signify that the respective parts are in physical contact with each other. For example, a heat transfer layer or plate may be placed between them, and even a thin layer of air can exist between the two. In certain cases, another thermoelectric module may also be placed between the two parts. However, a system which comprises a cooling liquid circuit to transfer the energy between the two parts cannot be regarded in this sense as being a thermal contact, since the transfer of energy is very different and indirect. It will be appreciated that the face of the thermoelectric module may itself in certain cases be adapted to engage an element.

The term “element” can correspond to a solid, a liquid or even a gas. Naturally the removable bell may be made of an insulating material in order to reduce the loss or gain of energy through the carafe.

After the device has been used to cool an element, the PCM may be completely melted and is therefore “used” for this particular application. The device may then be used, however, to heat something, this time by taking the energy from the same “used” PCM, which will be “unused” for this application. Also, once the device has performed temperature regulation, it may also function in the reverse direction, simply to re-freeze or re-melt the block, for example if there is no refrigerator available.

The embodiments described above are by way of examples and must not be interpreted in a restrictive manner. It should be noted that other embodiments or improvements to the invention will be obvious to those skilled in the art, without going beyond the general scope of the claims.

What is claimed is:

1. A portable device (100; 200; 400) for regulating the temperature of an element (1), said device comprising:
i) an engagement part (2) adapted to be placed in contact with the element (1),
ii) a temperature regulation unit (3) comprising a thermoelectric module (4) having two sides (41, 42),
a first side (41) of said thermoelectric module being thermally coupled with the engagement part (2),
characterised in that the device (100; 200; 400) further comprises:
iii) a reception part (5) adapted to removably receive a phase change material (PCM) (6),
a second side (42) of said thermoelectric module being thermally coupled with the reception part (5), such that a phase change material (PCM) (6) provided in said reception part will also be thermally coupled with said second side (42) of said thermoelectric module.

2. A device according to claim 1, characterised in that said engagement part (2) comprises a heat-transfer plate (25).

3. A device (200) according to claim 1, characterised in that the engagement part (2) comprises a carafe (21) for decanting and aerating a liquid.

4. A device according to claim 3, characterised in that the carafe is a carafe (21) comprising a removable bell (22) and a base (23), said base being a heat transfer-plate (25).

5. A device according to claim 1, characterised in that the engagement part (2), the temperature regulation unit (3) and the reception part (5) are integral with the device.

6. A device according to claim 5, characterised in that the entire device (200) is adapted to be tilted to pour a liquid from the device (200).

7. A device according to claim 1, characterised in that the reception part (5) comprises a phase change material (PCM) (6) of predetermined mass.

8. A device according to claim 7, characterised in that said phase change material (PCM) (6) is provided in a removable container (61).

9. A device according to claim 8, characterised in that said phase change material (PCM) (6) is a material chosen from amongst the following materials: water, paraffin, salt hydrates, dry ice (carbon dioxide), disodium orthophosphate dodecahydrate, wax, or any combination of two or more of these materials.

10. A device according to claim 7, characterised in that during use the thermal energy provided to or extracted from the element (1) by the thermoelectric module is substantially respectively extracted from or supplied to the phase change material (PCM) (6).

11. A device according to claim 1, characterised in that the temperature regulation unit (3) comprises a Peltier effect type of thermoelectric module (4).

12. A device according to claim 11, characterised in that the module (4) is controlled by a processor (31) as a function of a selected temperature.

13. A device according to claim 12, characterised in that the module is further controlled by the processor (31) as a function of a recommended time period.

14. A device according to claim 13, characterised in that the temperature for a wine is selected according to the type of wine selected, the processor (31) being fed a temperature from a database connected to the processor (31) depending on the type of wine selected, and also a recommended aeration period for said type of wine.

15. A method for regulating the temperature of an element (1) using a portable device (100; 200; 400) for regulating the temperature of an element (1) according to claim 1, wherein the method comprises the following steps:
i) thermally coupling a first side (41) of a thermoelectric module (4) exhibiting a first thermal effect with the element (1),
ii) removably providing a phase change material (PCM) (6) of predetermined mass,
iii) thermally coupling a second side (42) of said thermoelectric module (4) exhibiting a second effect with the phase change material (PCM) (6),
such that the energy supplied to or extracted from the element (1) is extracted from or supplied to the latent heat of the phase change material (PCM) (6), such that the phase change material (PCM) undergoes, at least in part, a change of phase.
